(19) United States
(12) Patent Application Publication
(10) Pub. No.: US 2011/0089099 A1
(43) Pub. Date: Apr. 21, 2011

(54) FOREIGN SUBSTANCE FILTERING FILM FOR DRAIN AND MEHOD FOR MANUFACTURING SAME

(76) Inventor: Ul-Ho Lee, Gyeonggi-do (KR)

(21) Appl. No.: 12/933,067

(22) PCT Filed: Mar. 9, 2009
(86) PCT No.: PCT/KR09/01145

§ 371 Date: Sep. 16, 2010

(30) Foreign Application Priority Data
Mar. 17, 2008 (KR) 10-2008-0024313
Jan. 28, 2009 (KR) 10-2009-0006540
Jan. 28, 2009 (KR) 10-2009-0006549

(51) Int. Cl. E03C 1/26; B01D 35/28

(52) U.S. Cl. 210/238

(57) ABSTRACT

A foreign substance filtering film for a drain of the present invention includes a main body having at least two or more through-holes; and a grip extended from an outer periphery of the main body such that the grip is spaced distant from the center of the main body. The grip extends from the film material and has a length at least one half longer than the width of the main body. The foreign substance filtering film improves sanitation and provides a reduction in user discomfort by enabling the user to easily hold the grip of the filtering film without the need for touching by hand, hair caught on the filtering film inserted into the socket of the drain. The present invention provides an inexpensive foreign substance filtering film for a drain that improves sanitation as it enables a user to discard the filtering film together with the foreign substance caught at the filtering film without the necessity of separating the filtering film from the socket of the drain, and to grasp the foreign substance with the filtering film.

### TECHNICAL FIELD

The present invention relates to a trash filter for preventing foreign substances from entering a drain through a drain hole, and more particularly, to a trash filter inserted/installed in a drain hole socket provided at the bottom of a bathtub to filter foreign substances mixed with water in the bathtub, preventing the foreign substances from entering a drain.

### BACKGROUND ART

In order to prevent foreign substances such as hair, etc., from entering a drain through the drain hole of a bathtub while a user takes a shower or bath, the bathtub includes a drain hole socket having a through-hole formed in the bottom of the socket and through which water passes, and a filter having spokes and rims to filter foreign substances such as hairs, etc.

In addition, the drain hole of the bathtub includes a plug for a drain hole for selectively receiving water in the bathtub or discharging the water from the bathtub through the drain hole.

While the conventional drain hole for a bathtub can filter foreign substances such as user's hairs, etc. to solve the problem of clogging the drain, a drain function decreases due to the foreign substances such as hairs, etc. filtered by the filter. In order to overcome this problem, a user must frequently grip the foreign substances such as hairs, etc., caught by the filter in the drain hole, and separate the foreign substances from the drain hole.

Here, gripping the foreign substances such as hairs, etc., filtered by the filter in the drain hole with the user's hand poses a sanitary problem and also gives the user an unpleasant feeling.

In order to overcome the problems, Korean Patent Laid-open Publication No. 10-2004-0086229 (hereinafter, referred to as “Cited Document 1”) and the related art shown in FIG. 4 of Cited Document 1 provide a method, which includes gripping a handle provided at a filter, which is formed of a plastic material, etc., and which can be inserted into and separated from a drain hole socket, rather than directly gripping foreign substances such as hairs, etc., to separate the foreign substances from the filter, and inserting the filter into the drain hole socket again.

However, in Cited Document 1 and the related art, since the handle of the filter must be formed at a lower level than that of the plug for a drain hole, the handle of the filter is submerged in water, soap, etc., making it difficult for a user to grip the handle.

In addition, since the filter of Cited Document 1 and the related art has the shape of a grill having spokes and rims and thus the foreign substances such as hairs, etc., tangled in the filter cannot be readily removed therefrom, the user must separate the filter from the drain hole socket and grip the foreign substances on the filter to remove them from the filter, causing a sanitary problem and giving the user an unpleasant feeling.

Further, since the filter of Cited Document 1 and the related art must be reused, cleaning the filter after removing the foreign substances from the filter is very troublesome.

Furthermore, since the filter of Cited Document 1 and the related art is formed of plastic through injection molding, the filter is too expensive to use as a disposable member.

Korean Utility Model Registration No. 20-0308576 (hereinafter, referred to as “Cited Document 2”) discloses a sticker-type disposable filter including a porous film having one surface, to which adhesive is applied, in order to solve the problems of Cited Document 1 and the related art disclosed in Cited Document 1.

Here, the disposable filter of Cited Document 2 must be used in a manner that the filter is adhered to a drain hole before use, and then, the filter is removed from the drain hole after a shower or bath. However, since the adhesion of the filter may be weakened due to the moist environment and much water flow, the filter may become separated from the drain hole during a bath or shower.

In addition, since the disposable filter of Cited Document 2 must be adhered to the drain hole before use, it is necessary to clean water around the drain hole before adhesion. For this reason, it is inconvenient for a user to wipe the watery drain hole dry.

Further, while the disposable filter of Cited Document 2 can be easily used in a flat drain hole, when the filter is used in a drain hole socket, which is concaved like a bathtub drain hole, or an uneven drain hole, it is very inconvenient to use the filter and the filter may easily become separated from the drain hole during use thereof.

### DISCLOSURE

### Technical Problem

In order to solve the foregoing and/or other problems, it is an aspect of the present invention to provide a filter structure inserted into a drain hole socket capable of easily gripping a handle of the filter structure in the drain hole, rather than gripping foreign substances such as hairs, etc., tangled in the filter structure with a user's hand, solving a sanitary problem and removing an unpleasant feeling of the user.

It is another aspect of the present invention to provide a filter structure inserted into a drain hole socket capable of solving a problem that a user must separate the filter structure from the drain hole socket, grip foreign substances in the filter structure with a user's hand to remove the foreign substances from the filter structure, and clean the filter to reuse the filter.

### Technical Solution

The foregoing and/or other aspects of the present invention may be achieved by providing a trash filter for a drain hole including: a main body having at least two through-holes; and a grip part extending from an outer circumference of the main body in a direction away from the center of the main body, wherein the grip part has a length equal to or larger than ½ of a width of the main body.

Another aspect of the present invention may be achieved by providing a trash filter for a drain hole including: a main body having at least two through-holes and spokes and rims defined by the at least two through-holes; and a grip part extending from a central rim of the main body to project away from the central rim of the main body and spaced apart from an outermost rim of the main body.

In addition, the main body may be integrally formed with the grip part.

Further, the grip part may include a bending part having at least one of a notch, a groove and a hole formed in a region contacting the main body.

Furthermore, the grip part may be provided as a pair of grip parts projecting from the main body in opposite directions.

In addition, in the trash filter for a drain hole, the pair of grip parts may be disposed to be symmetrical about the center of the main body, and may include fastening parts formed far from the center of the main body, respectively.

Further, the fastening part may be a groove or projection recessed or projecting from the width of the grip part.

Furthermore, the fastening parts included in the pair of grip parts, respectively, may be formed on the grip parts in the same clockwise direction or counterclockwise direction about the center of the main body.

In addition, in the trash filter for a drain hole according to one embodiment, the grip part may have a length larger than a width of the main body and equal to or smaller than two times a width of the main body.

Further, in the trash filter for a drain hole according to another embodiment, the grip part may have a length smaller than ½ of a width of the main body.

### Advantageous Effects

According to the present invention, it is possible to provide a trash filter for a drain hole capable of easily gripping a grip part of the filter, rather than gripping foreign substances such as hair, etc., tangled in the filter inserted into a drain hole socket with a user's hand, solving a problem that gives the user an unpleasant feeling.

In addition, according to the present invention, it is possible to provide an inexpensive filter for a drain hole capable of being discarded, to which foreign substances are adhered, with no necessity of separating the filter from the drain hole socket and then gripping the foreign substances with a user's hand to remove the foreign substances from the filter, improving use convenience.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 is a plan view of a trash filter in accordance with a first exemplary embodiment of the present invention;

FIG. 2 is a plan view of a trash filter in accordance with a second exemplary embodiment of the present invention;

FIG. 3 is a plan view of a trash filter in accordance with a third exemplary embodiment of the present invention;

FIG. 4 is a plan view of a trash filter in accordance with a fourth exemplary embodiment of the present invention;

FIG. 5 is a perspective view of the trash filter in accordance with the third exemplary embodiment of the present invention shown in FIG. 3, showing grip parts of the trash filter fastened to each other;

FIG. 6 is a perspective view of the trash filter in accordance with the fourth exemplary embodiment of the present invention shown in FIG. 4, showing grip parts of the trash filter fastened to each other;

FIG. 7 is a perspective view showing a process of inserting the trash filter in accordance with an exemplary embodiment of the present invention into a drain hole;

FIG. 8 is a perspective view showing a bundle of trash filters in accordance with an exemplary embodiment of the present invention inserted into a case;

FIG. 9 is a perspective view of a trash filter production apparatus for producing a trash filter in accordance with an exemplary embodiment of the present invention; and

FIG. 10 is a perspective view of a trash filter production apparatus for producing a trash filter in accordance with another exemplary embodiment of the present invention.

### DESCRIPTION OF MAJOR REFERENCE NUMERALS

100, 200, 300, 400: Filter
110, 210, 310, 410: Main body
120, 220, 230, 320, 330, 420, 430: Grip part
223, 233, 323, 333, 423, 432: Fastening part
1000: Bundle case
2110, 2120: First press
2210, 2220: Second press

### MODE FOR INVENTION

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. In the drawings, like reference numerals designate like elements throughout the invention.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention is directed to a trash filter inserted into a drain hole socket of a bathtub including a main body having a through-hole through which water passes, and a grip part extending inward or outward from an outer circumference of the main body so that a user can bend the grip part from the main body to grip the grip part, in order to separate the filter from the socket after the filter inserted into the drain hole socket is used.

In addition, the trash filter in accordance with the present invention may be produced in a film type, which may be formed of a material which is not deformed or weakened due to permeation of water, for example, polymers such as polystyrene (PS), polyethylene (PE), polyethylene terephthalate (PET), or the like.

Further, the trash filter in accordance with the present invention may be formed of a material such as paper into which moisture permeates, and the material may be coated with a film to prevent moisture from permeating into the material.

Furthermore, the trash filter in accordance with the present invention may have a thickness to prevent the trash filter from easily bending due to impacts or flow of water draining through the drain hole or dropping from a tap. The thickness may be different according to materials used in the trash filter.

The trash filter may be formed of PET, and may have a thickness of 1 mm or less, more preferably, 0.01 mm to 0.5 mm.

Hereinafter, various embodiments of a trash filter and an apparatus for producing the same in accordance with the present invention will be described in detail with reference to the accompanying drawings.

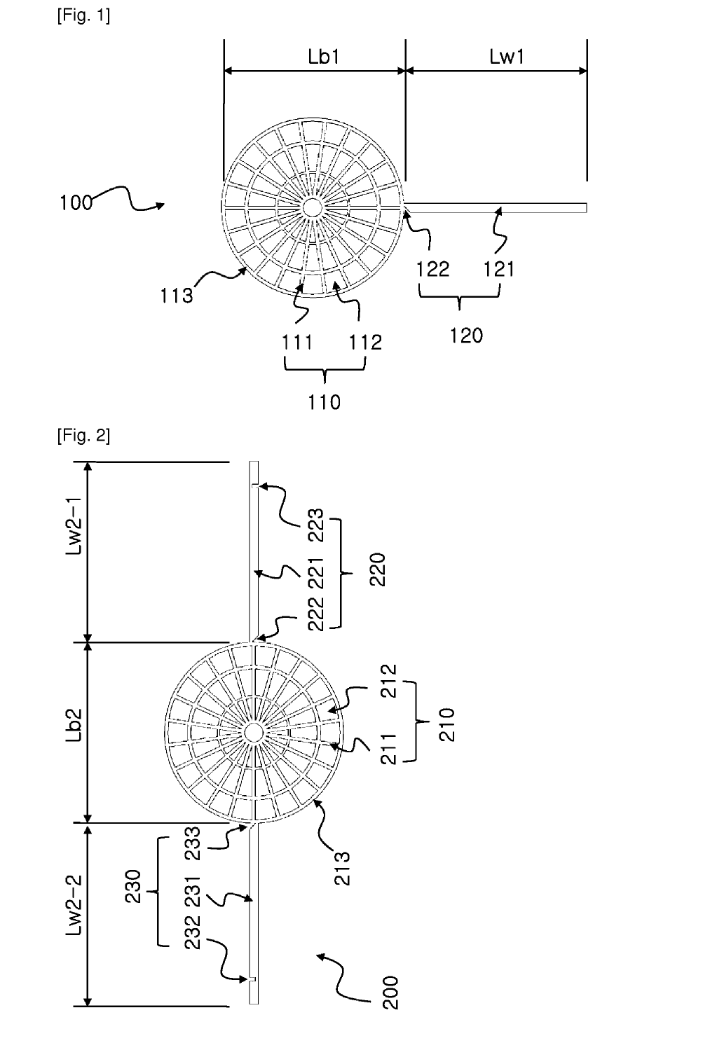

Trash filters in accordance with various embodiments of the present invention will be described with reference to FIGS. 1 to 7.

FIG. 1 is a plan view of a trash filter in accordance with a first exemplary embodiment of the present invention.

A trash filter 100 in accordance with the first exemplary embodiment of the present invention includes a main body 110 for filtering foreign substances, and a grip part 120 easily gripped by a user to insert the trash filter 100 into a drain hole socket or separate the trash filter 100 from the socket.

The main body 110 is formed of the above-mentioned film, and has through-holes 112 formed in the main body 110 and through which liquid passes.

Spokes and rims 111 and 113 forming a frame of the main body and defining the through-holes 112 function to filter foreign substances included in liquid when the trash filter 100 in accordance with the present invention is used.

The grip part 120 extends from a predetermined region of the rim 113 disposed at the outer periphery of the main body 110 to project outward from the main body 110.

In addition, at least two through-holes, preferably at least six through-holes 112, of the main body 110 may be radially disposed, the shape or number of which may be variously modified for use convenience, aesthetic purpose, or the like.

Further, the profile of the main body 110, i.e., the rim 113 disposed at the outer circumference of the main body 110 has the same shape as the drain hole socket. The main body 110 may have a width Lb1 slightly smaller than the inner diameter, i.e., the inner width, of the drain hole socket such that the filter can be easily inserted into and separated from the drain hole socket but foreign substances cannot pass between the outer rim 113 and the drain hole socket.

Furthermore, the grip part 120 may include a grip region 121 gripped by a user, and a bending part 122 formed of a notch, a groove, a hole, or the like, so that the grip part 120 can be easily bent with respect to the main body 110.

In addition, the grip part 120 may have a length Lw1 equal to ¼ or larger than a width Lb1 of the main body 110, so that a user can easily grip the grip part 120. More preferably, the grip part 120 may have a length Lw1 equal to ½ to 2 times the width Lb1 of the main body 110 so that the grip part cannot excessively project from the height of the drain hole socket.

In order to prevent the trash filter from turning over in the drain hole socket due to impacts or flow of water draining through the drain hole or dropping from a tap when the trash filter in accordance with an exemplary embodiment of the present invention is inserted and used in the drain hole socket, the grip part 120 may have a length Lw1 larger than an inner diameter of the drain hole socket or larger than the width Lb1 of the main body 110.

In addition, since the trash filter 100 in accordance with an exemplary embodiment of the present invention may be formed of a film so that the grip part 120 is pushed by a plug of the drain hole socket to be bent, the grip part 120 may have a length Lw1 larger than the depth of the drain hole socket. However, provided that the length Lw1 of the grip part 120 is larger than a sum of the depth of the drain hole socket and the inner diameter of the drain hole socket, since the grip part may be bent when the plug of the drain hole socket is covered, the length Lw1 of the grip part 120 may be smaller than or equal to the sum of the depth of the drain hole socket and the inner diameter of the drain hole socket. Therefore, since the depth of the drain hole socket is generally similar to the inner diameter of the drain hole socket while the standard of the drain hole socket may be different according to countries, the length Lw1 of the grip part may be smaller than or equal to two times a width Lb1 of the main body 110.

While the respective components of the main body 110 and the grip part 120 are separately described for the purpose of functional discrimination, the main body 110 may be integrally formed with the grip part 120 by processing one film.

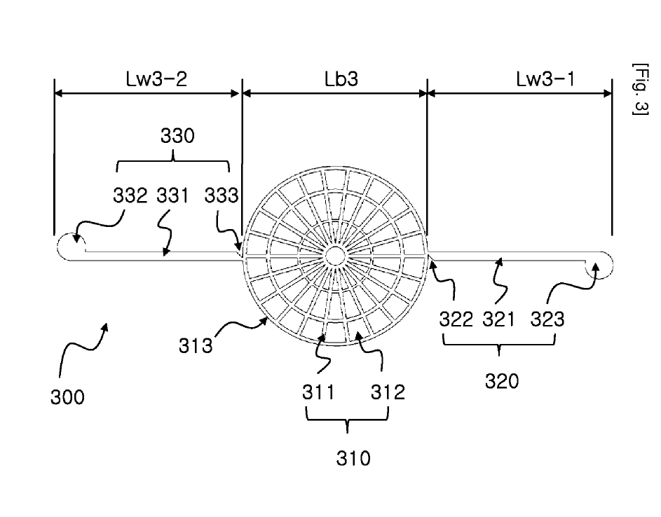

Since the trash filter in accordance with the first exemplary embodiment of the present invention described with reference to FIG. 1 includes one grip part 120 disposed on one side of the main body, when a large amount of foreign substances is on the main body 110 upon separation of the trash filter 100 from the drain hole socket, the bending part 122 may be spread and some or all of the foreign substances may be separated from the main body 110 during conveyance to a garbage can, etc. Therefore, similar to second to fourth embodiments of the present invention shown in FIGS. 2 to 4, at least two grip parts may be provided at the main body.

FIG. 2 is a plan view of a trash filter in accordance with a second exemplary embodiment of the present invention, and FIG. 3 is a plan view of a trash filter in accordance with a third exemplary embodiment of the present invention.

Each of the trash filters 200 and 300 in accordance with the second and third exemplary embodiments of the present invention has the same construction as the main body 110 of the trash filter 100 of the first embodiment, and includes a pair of grip parts 220 and 230 or 320 and 330 modified from the first embodiment.

First, the trash filter 200 in accordance with the second exemplary embodiment of the present invention will be described with reference to FIG. 2.

A main body 210 includes through-holes 212 through which liquid passes and spikes and rims 211 foaming a frame of the main body. The pair of grip parts 220 and 230 extend from opposite regions of the rim 211 corresponding to an outer circumference of the main body to project outward from the main body 210.

Since the shape and construction of the main body 210 are similar to those of the first embodiment described with reference to FIG. 1, detailed description thereof will not be repeated.

The grip parts 220 and 230 may include grip regions 221 and 231 gripped by a user, bending parts 222 and 232 formed of notches, grooves, or holes to be easily bent with respect to the main body 210, and fastening parts 223 and 233 for fastening the pair of grip parts 220 and 230 to each other when the grip parts are bent by the bending parts 222 and 232.

In addition, the grip parts 220 and 230 have lengths Lw2-1 and Lw2-2 larger than ½ of a width Lb2 of the main body to be fastened to each other by the fastening parts. More preferably, the length from the bending parts 222 and 232 to the fastening parts 223 and 233 in the length of the grip parts 220 and 230 may be equal to or longer than ½ of the width Lb2 of the main body 210.

In order to prevent the trash filter from turning over in the drain hole socket due to impacts or flow of water draining through the drain hole or dropping from a tap when the trash filter 200 in accordance with an exemplary embodiment of the present invention is inserted and used in the drain hole socket, the grip parts 220 and 230 may have lengths Lw2-1 and Lw2-2 larger than an inner diameter of the drain hole socket or larger than the width Lb2 of the main body 210.

In addition, since the trash filter 200 in accordance with an exemplary embodiment of the present invention may be formed of a film so that the grip parts 220 and 230 are pushed by a plug of the drain hole socket to be bent, the grip parts 220 and 230 may have lengths Lw2-1 and Lw2-2 larger than the depth of the drain hole socket. However, provided that the lengths Lw2-1 and Lw2-2 of the grip parts 220 and 230 are larger than a sum of the depth of the drain hole socket and the inner diameter of the drain hole socket, since the grip parts may be bent when the plug of the drain hole socket is covered, the lengths Lw2-1 and Lw2-2 of the grip parts 220 and 230 may be smaller than or equal to the sum of the depth of the drain hole socket and the inner diameter of the drain hole socket. Therefore, since the depth of the drain hole socket is generally similar to the inner diameter of the drain hole socket while the standard of the drain hole socket may be different according to countries, the lengths Lw2-1 and Lw2-2 of the grip parts may be smaller than or equal to two times a width Lb2 of the main body 210.

Further, the fastening parts 223 and 233 may be grooves formed in the same clockwise or counterclockwise direction about the center of the main body 210 to be fastened to each other.

Furthermore, the grip parts 220 and 230 are configured so that at least portions of the grip regions 221 and 231 of the grip parts 220 and 230 overlap each other when the grip parts 220 and 230 overlap each other using the bending parts 222 and 232. Therefore, the grip parts 220 and 230 are fastened to each other using the fastening parts 223 and 233 to increase a fastening force so that the fastening parts cannot be unfastened due to impacts and flow of fluid dropping from above while the trash filter 200 is in use.

For this reason, a distance between central axes of the grip parts 220 and 230 may be smaller than or equal to each of the widths of the grip parts 220 and 230.

In addition, while the respective components of the main body 210 and the grip parts 220 and 230 have been separately described for the purpose of functional discrimination, the main body 210 may be integrally formed with the grip parts 220 and 230 by processing one film only.

The third embodiment, in which the shape of the fastening parts of the second embodiment is partially modified, will be described below with reference to FIG. 3.

A main body 310 includes through-holes 312 through which liquid passes, and spikes and rims 311 forming a frame of the main body. The pair of grip parts 320 and 330 extend from opposite regions of the rim 311 corresponding to an outer circumference of the main body to project outward from the main body 310.

Since the shape and construction of the main body 310 are similar to those of the first embodiment described with reference to FIG. 1, detailed description thereof will not be repeated.

The grip parts 320 and 330 may include grip regions 321 and 331 gripped by a user, bending parts 322 and 332 formed of notches, grooves, or holes to be easily bent with respect to the main body 310, and fastening parts 323 and 333 for fastening the pair of grip parts 320 and 330 to each other when the grip parts are bent by the bending parts 322 and 332.

In addition, the grip parts 320 and 330 have lengths Lw3-1 and Lw3-2 larger than ½ of a width Lb3 of the main body 310 to be fastened to each other by the fastening parts. More preferably, the length from the bending parts 322 and 332 to the fastening parts 323 and 333 in the length of the grip parts 320 and 330 may be equal to or longer than ½ of the width Lb3 of the main body 310.

In order to prevent the trash filter from turning over in the drain hole socket due to impacts or flow of water draining through the drain hole or dropping from a tap when the trash filter 300 in accordance with an exemplary embodiment of the present invention is inserted and used in the drain hole socket, the grip parts 320 and 330 may have lengths Lw3-1 and Lw3-2 larger than an inner diameter of the drain hole socket or larger than the width Lb3 of the main body 310.

In addition, since the trash filter 300 in accordance with an exemplary embodiment of the present invention may be formed of a film so that the grip parts 320 and 330 are pushed by a plug of the drain hole socket to be bent, the grip parts 320 and 330 may have lengths Lw3-1 and Lw3-2 larger than the depth of the drain hole socket. However, provided that the lengths Lw3-1 and Lw3-2 of the grip parts 320 and 330 are larger than a sum of the depth of the drain hole socket and the inner diameter of the drain hole socket, since the grip parts may be bent when the plug of the drain hole socket is covered, the lengths Lw3-1 and Lw3-2 of the grip parts 320 and 330 may be smaller than or equal to the sum of the depth of the drain hole socket and the inner diameter of the drain hole socket. Therefore, although the standard of the drain hole socked may differ by country, since the depth of the drain hole socket is generally similar to the inner diameter of the drain hole socket, the lengths Lw3-1 and Lw3-2 of the grip parts may be smaller than or equal to two times a width Lb3 of the main body 310.

Further, the fastening parts 323 and 333 may be projections projecting from grip regions 321 and 331 of the grip parts 320 and 330 in the same clockwise or counterclockwise direction about the center of the main body 310 to be fastened to each other.

Therefore, the fastening parts 323 and 333 formed of the projections have a relatively large area so that a manufacturer's logo, etc., can be printed and a user can easily grip the grip parts.

Furthermore, the grip parts 320 and 330 are configured so that at least portions of the grip regions 321 and 331 of the grip parts 320 and 330 overlap each other when the grip parts 320 and 330 overlap each other using the bending parts 322 and 332. Therefore, the grip parts 320 and 330 are fastened to each other using the fastening parts 323 and 333 to increase a fastening force so that the fastening parts cannot be unfastened due to impacts and flow of fluid dropping from above while the trash filter 300 is in use.

For this reason, a distance between central axes of the grip parts 320 and 330 may be equal to or smaller than each of the widths of the grip parts 320 and 330.

In addition, while the respective components of the main body 310 and the grip parts 320 and 330 have been separately described for the purpose of functional discrimination, the main body 310 may be integrally formed with the grip parts 320 and 330 by processing one film only.

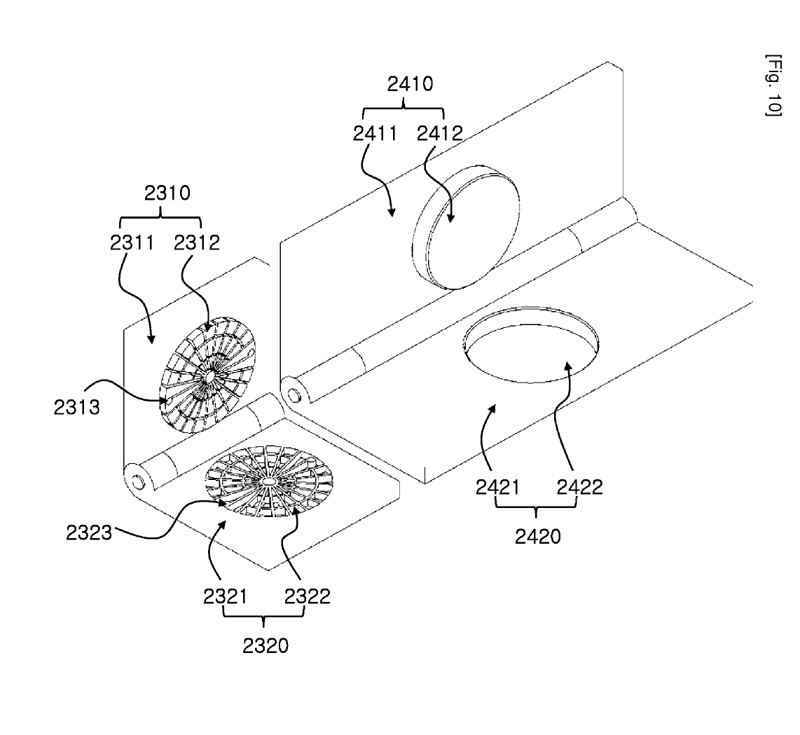

Further, since the first to third embodiments described with reference to FIGS. 1 to 3 include the grip parts projecting from the outer circumference of the main body, a large region of a raw film for manufacturing the trash filter may be wasted during a manufacturing process described below with reference to FIG. 9.

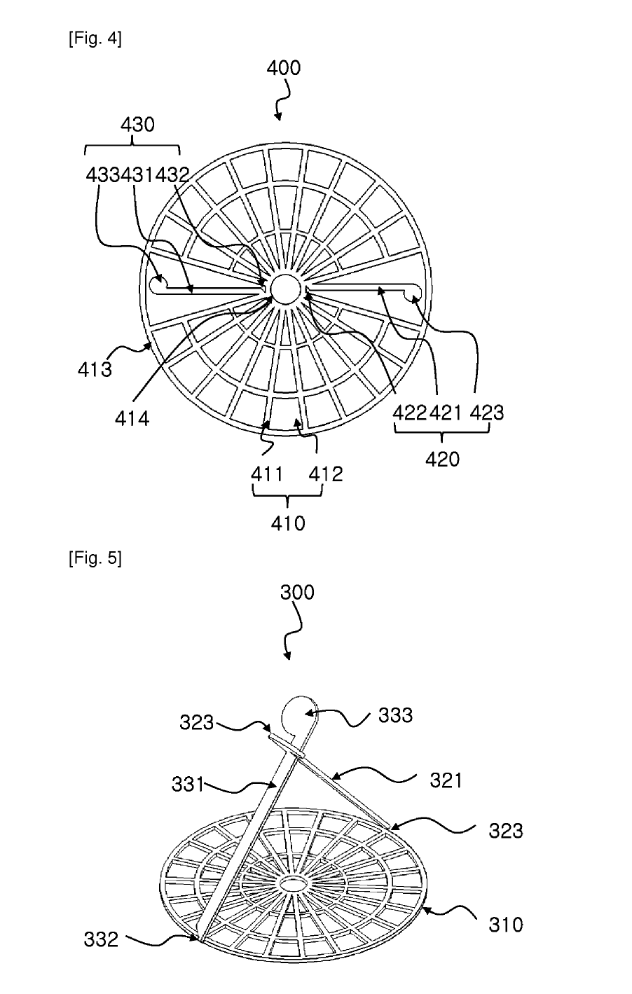

Therefore, since the trash filter in accordance with a fourth exemplary embodiment of the present invention described with reference to FIG. 4 includes grip parts disposed inside the outer circumference of the main body, a large region of the raw film for manufacturing the trash filter during a manufacturing process can be saved.

Hereinafter, a trash filter 400 in accordance with the fourth exemplary embodiment of the present invention will be described in detail with reference to FIG. 4.

A main body 410 includes through-holes 412 through which liquid passes, and spokes and rims 411 forming a frame of the main body. A pair of grip parts 420 and 430 extend from opposite regions of the rim 411 corresponding to an inner circumference of the main body to project outward from the main body 310 toward an outer circumference 413 of the main body 410 to be spaced apart from the outer circumference.

Here, the grip parts 420 and 430 may extend from the rim 411 disposed within a distance from the center of the main body 410 smaller than ½ of a radius of the main body 410.

In addition, the grip parts 420 and 430 may include grip regions 421 and 431 gripped by a user, bending parts 422 and 432 formed of notches, grooves, or holes to be easily bent with respect to the main body 410, and fastening parts 423 and 433 for fastening the pair of grip parts 420 and 430 to each other when the grip parts are bent by the bending parts 422 and 432.

Further, the grip parts 420 and 430 may have lengths smaller than ½ of a width of the main body 410, i.e., an outer diameter of the main body 410.

Furthermore, distal ends of the grip parts 420 and 430 connected to the main body 410 are spaced apart from the rim corresponding to an outer circumference 413 of the main body 410, and grip regions 421 and 431 of the grip parts 420 and 430 are spaced apart from the spokes 411 of the main body 410, except for connection parts to the main body 410 corresponding to positions of the bending parts 422 and 432.

In addition, the fastening parts 423 and 433 are formed at the grip parts 420 and 430 in the same clockwise or counterclockwise direction about the center of the main body 410 to be fastened to each other. The fastening parts 423 and 433 may be the grooves in the second embodiment described with reference to FIG. 2, or may be the projections in the third embodiment described with reference to FIG. 3. In an embodiment of the present invention, the fastening parts are formed as the projections projecting from the grip regions 421 and 431 of the grip parts.

Therefore, the fastening parts 423 and 433 formed of the projections have a relatively large area so that a manufacturer's logo, etc., can be printed and a user can easily grip the grip parts.

Furthermore, the grip parts 420 and 430 are configured so that at least portions of the grip regions 421 and 431 of the grip parts 420 and 430 overlap each other when the grip parts 420 and 430 overlap each other using the bending parts 422 and 432. Therefore, the grip parts 420 and 430 are fastened to each other using the fastening parts 423 and 433 to increase a fastening force so that the fastening parts cannot be unfastened due to impacts and flow of fluid dropping from above while the trash filter 400 is in use.

For this reason, a distance between central axes of the grip parts 420 and 430 may be equal to or smaller than each of the widths of the grip parts 420 and 430.

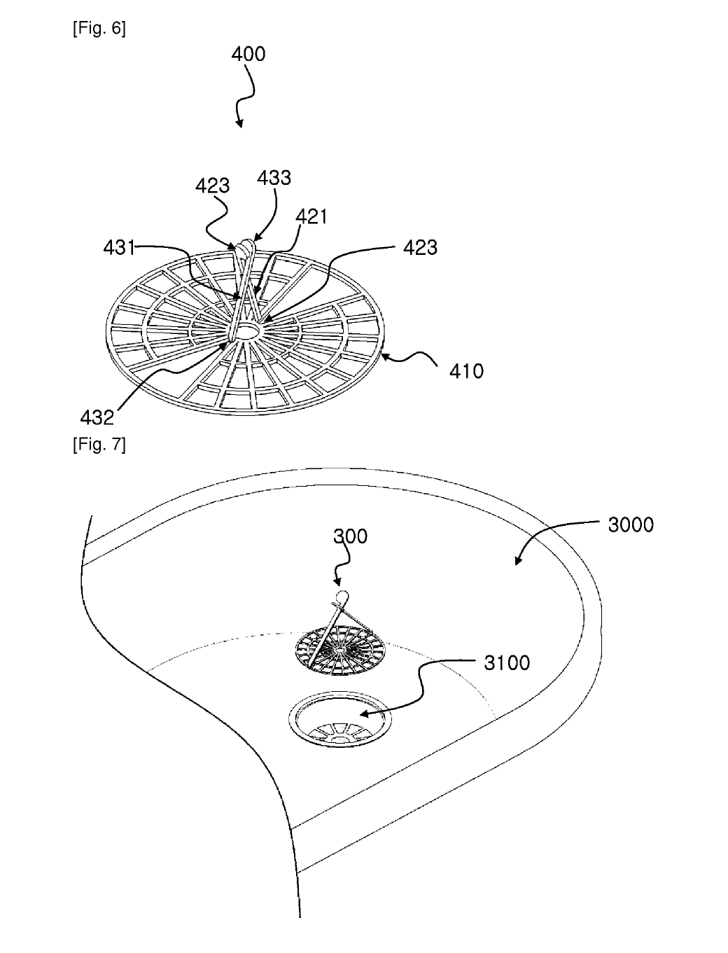

FIG. 5 is a perspective view of the trash filter in accordance with the third exemplary embodiment of the present invention shown in FIG. 3, with grip parts of the trash filter being fastened to each other, and FIG. 6 is a perspective view of the trash filter in accordance with the fourth exemplary embodiment of the present invention shown in FIG. 4, with grip parts of the trash filter being fastened to each other.

While perspective views of the first and second embodiments are not shown, the method of bending the grip parts with respect to the main body using the bending parts of the grip parts is the same as above. In particular, since the second embodiment employs the same method of bending the grip parts with respect to the main body and then fastening the pair of grip parts using the fastening parts of the grip parts and a fastening method is described with reference to FIGS. 1 to 4, detailed description thereof will not be repeated.

FIG. 7 is a perspective view showing a process of fastening the trash filter and then inserting the trash filter into a drain hole socket.

A user uses the trash filter in accordance with various exemplary embodiments of the present invention described with reference to FIGS. 1 to 4 by bending the grip parts with respect to the main body, fastening the grip parts using the fastening parts, and then inserting the filter into a drain hole socket 3100 of a bathtub 3000.

After taking a bath or shower, the user can grip the fastened grip parts of the trash filter to separate the trash filter from the drain hole socket 3100 to discard the trash filter into a garbage can so that foreign substances cannot block the drain hole socket, keeping the bathtub clean. In addition, the user can grip the grip parts of the trash filter to remove the foreign substances, not touching the foreign substances, thereby removing an unpleasant feeling of the user.

Further, since the trash filter in accordance with the present invention is formed of a film, the grip parts may be bent. When a user plugs the plug into the drain hole socket to draw water for a bath, etc., in a bathtub, since the height of the fastened trash filter may be larger than the height of the drain hole defined by the depth of the drain hole socket 3100 and the plug, a user can easily grip the trash filter.

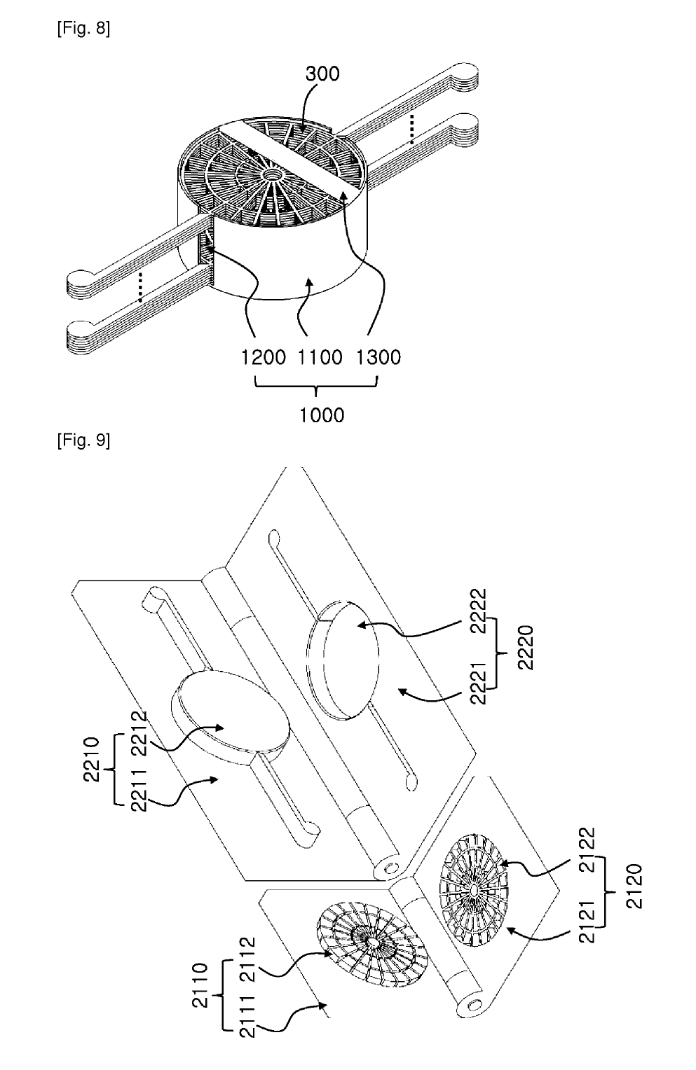

FIG. 8 is a perspective view showing a bundle of trash filters and a case thereof so that a user can dispose of the case, in which a plurality of trash filters are stacked, at a position adjacent to a drain hole to extract and use the trash filters one by one.

A trash filter bundle case 1000 includes a side support part 1100 for supporting side surfaces of trash filters, an upper support part 1300 for supporting an upper surface of the trash filter bundle, and a lower support part for supporting a lower surface of the trash filter bundle.

While FIG. 8 shows the side support part 1100 formed in a cylindrical shape, the side support part may have various shapes such as a rectangular or pentagonal column, etc., to allow the main bodies of the trash filters to be inserted.

In addition, the side support part 1100 may further include a grip part seating hole 1200 for seating grip parts of the trash filters, in the case that the grip parts projects outward from the main bodies, like the trash filter of the first to third embodiments described with reference to FIGS. 1 to 3, or may not include the grip part seating hole 1200, in the case that the bundle of trash filters in accordance with the fourth exemplary embodiment of the present invention described with reference to FIG. 4 is used.

Further, the upper support part 1300 has a length smaller than a maximum distance between corners of the case 1000, when seen from a plan view, so that the trash filters 300 can be extracted from the case 1000 one by one. That is, when the case 1000 has a cylindrical shape, the upper support part 1300 has a length smaller than a diameter of the cylindrical shape so that the upper support part 1300 does not cover the centerline of the cylindrical shape.

Therefore, the upper support part 1300 may have a smaller area than a semi-circular part of the cylindrical cross-section of the case 1000.

FIG. 9 is a perspective view of a trash filter production apparatus for producing a trash filter in accordance with an exemplary embodiment of the present invention.

The trash filter production apparatus in accordance with an exemplary embodiment of the present invention includes a first press 2110 and 2120 including a pair of a male part 2110 and a female part 2120 for forming through-holes formed in a main body of a trash filter, and a second press 2210 and 2220 including a pair of a male part 2110 and a female part 2120 for forming a profile including an outer circumference of the trash filter.

That is, in a first process of forming through-holes, a film is supplied to the first press to be sandwiched between projections 2112 formed at a body 2111 of the male part 2110 of the first press and recesses 2122 formed in a body 2121 of the female part 2120, forming through-holes in a region of the supplied film corresponding to the projections 2112 and the recesses 2122.

In a second process of forming profiles of the trash filters, after the first process, the film in which the through-holes are formed is supplied to the second press, the film is sandwiched between projections 2212 formed at a body 2211 of the male part 2210 and recesses 2222 formed in a body 2221 of the female part 2220, and a profile of the trash filter is formed at a region of the filter, through which the through-holes are formed, corresponding to the projections 2212 and the recesses 2222, manufacturing the trash filter.

In addition, in the second process, the projections 2212 of the male part 2210 and the recesses 2222 of the female part 2220 of the second press are formed to correspond to the profile of the trash filter including a circular shape corresponding to the outer circumference of the main body and a region extending from the outer circumference of the main body corresponding to the grip parts.

Further, the recesses 2122 of the first press and the recesses 2222 of the second press may be grooves or through-holes formed in the press body.

Furthermore, relative movement between the male part 2110 or 2210 and the female part 2120 or 2220 of the first and second presses may be performed by a pivot hinge or a sliding hinge between the body 2111 or 2211 of the male part and the body 2121 or 2221 of the female part.

FIG. 10 is a perspective view of a trash filter production apparatus for producing a trash filter in accordance with another exemplary embodiment of the present invention, producing the trash filters in accordance with the fourth embodiment described with reference to FIG. 4.

The apparatus of FIG. 10 is similar to the apparatus described with reference to FIG. 9, except for a region corresponding to the grip parts.

The trash filter production apparatus in accordance with another exemplary embodiment of the present invention includes a first press 2310 and 2320 including a pair of a male part 2310 and a female part 2320 for forming through-holes formed in a main body of a trash filter, and a second press 2410 and 2420 including a pair of a male part 2410 and a female part 2420 for forming a profile including an outer circumference of the trash filter.

That is, in a first process of forming through-holes, a film is supplied to the first press to be sandwiched between projections 2312 formed at a body 2311 of the male part 2310 of the first press and recesses 2322 formed in a body 2321 of the female part 2320, forming through-holes in a region of the supplied film corresponding to the projections 2312 and the recesses 2322.

In a second process of forming profiles of the trash filters, after the first process, the film in which the through-holes are formed is supplied to the second press, the film is sandwiched between projections 2412 formed at a body 2411 of the male part 2410 and recesses 2422 formed in a body 2421 of the female part 2420, and a profile of the trash filter is formed at a region of the filter, through which the through-holes are formed, corresponding to the projections 2412 and the recesses 2422, manufacturing the trash filter.

Further, in the first process, the projections 2312 of the male part 3210 and the recesses 2322 of the female part 2320 of the first press may further include regions 2313 and 2323 corresponding to the grip parts formed inside the outer periphery of the main body of the trash filter.

In addition, in the second process, the projections 2412 of the male part 2410 and the recesses 2422 of the female part 2420 of the second press are formed to correspond to the profile of the main body of the trash filter.

Further, the recesses 2322 of the first press and the recesses 2422 of the second press may be grooves or through-holes formed in the press body.

Furthermore, relative movement between the male part 2310 or 2410 and the female part 2320 or 2420 of the first and second presses may be performed by a pivot hinge or a sliding hinge between the body 2311 or 2411 of the male part and the body 2321 or 2421 of the female part.

The foregoing description for exemplary embodiments of the invention is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

1. A trash filter for a drain hole, comprising:
a main body having at least two through-holes; and
a grip part extending from an outer circumference of the main body in a direction away from a center of the main body,
wherein the grip part has a length larger than or equal to ½ of a width of the main body.

2. A trash filter for a drain hole, comprising:
a main body having spokes and rims and at least two through-holes defined by the spokes and rims; and
a grip part extending from a central rim of the main body to project away from the central rim of the main body and spaced apart from an outermost rim of the main body.

3. The trash filter according to claim 1, wherein the main body is integrally formed with the grip part.

4. The trash filter according to claim 1, wherein the grip part comprises a bending part having at least one of a notch, a groove and a hole formed in a region contacting the main body.

5. The trash filter according to claim 1, wherein the grip part is provided as a pair of grip parts projecting from the main body in opposite directions.

6. The trash filter according to claim 1, wherein the grip part is provided as a pair of grip parts projecting from the main body in opposite directions, and the pair of grip parts are disposed to be symmetrical about the center of the main body and include fastening parts formed far from the center of the main body, respectively.

7. The trash filter according to claim 1, wherein the grip part is provided as a pair of grip parts projecting from the main body in opposite directions, the pair of grip parts are disposed to be symmetrical about the center of the main body and include fastening parts formed far from the center of the main body, respectively, and the fastening part is a groove or projection recessed or projecting from the width of the grip part.

8. The trash filter according to claim 1, wherein the grip part is provided as a pair of grip parts projecting from the main body in opposite directions, the pair of grip parts are disposed to be symmetrical about the center of the main body and include fastening parts formed far from the center of the main body, respectively, and the fastening parts included in the pair of grip parts, respectively, are formed on the grip parts in the same clockwise direction or counterclockwise direction about the center of the main body.

9. The trash filter according to claim 1, wherein the grip part has a length larger than a width of the main body and smaller than or equal to two times the width of the main body.

10. The trash filter according to claim 2, wherein the grip part has a length smaller than ½ of a width of the main body.

11. The trash filter according to claim 2, wherein the main body is integrally formed with the grip part.

12. The trash filter according to claim 2, wherein the grip part comprises a bending part having at least one of a notch, a groove and a hole formed in a region contacting the main body.

13. The trash filter according to claim 2, wherein the grip part is provided as a pair of grip parts projecting from the main body in opposite directions.

14. The trash filter according to claim 2, wherein the grip part is provided as a pair of grip parts projecting from the main body in opposite directions, and the pair of grip parts are disposed to be symmetrical about the center of the main body and include fastening parts formed far from the center of the main body, respectively.

15. The trash filter according to claim 2, wherein the grip part is provided as a pair of grip parts projecting from the main body in opposite directions, the pair of grip parts are disposed to be symmetrical about the center of the main body and include fastening parts formed far from the center of the main body, respectively, and the fastening part is a groove or projection recessed or projecting from the width of the grip part.

16. The trash filter according to claim 2, wherein the grip part is provided as a pair of grip parts projecting from the main body in opposite directions, the pair of grip parts are disposed to be symmetrical about the center of the main body and include fastening parts formed far from the center of the main body, respectively, and the fastening parts included in the pair of grip parts, respectively, are formed on the grip parts in the same clockwise direction or counterclockwise direction about the center of the main body.
